(19) United States
(12) Patent Application Publication
(10) Pub. No.: US 2024/0310928 A1
(43) Pub. Date: Sep. 19, 2024

(54) INPUT SYSTEM, INPUT METHOD AND PROGRAM

(71) Applicant: NIPPON TELEGRAPH AND TELEPHONE CORPORATION, Tokyo (JP)

(72) Inventors: Ryosuke AOKI, Tokyo (JP); Yukio KOIKE, Tokyo (JP)

(21) Appl. No.: 18/576,845

(22) PCT Filed: Jul. 8, 2021
(86) PCT No.: PCT/JP2021/025814

§ 371 Date: Jan. 5, 2024

(51) Int. Cl. G06F 3/033

(52) U.S. Cl. CPC G06F 3/033

(57) ABSTRACT

An input system includes an input device and an information processing device, in which the input device includes: an operation unit that includes a plurality of protrusions and receives operation by a body of an operator; and a sensor that measures a three-dimensional pressure value obtained by pressing by the plurality of protrusions, and the information processing device includes: a measurement value receiving unit that receives data indicating a measurement value from the input device; and a measurement value processing unit that selects a character to be input on the basis of the measurement value.

### TECHNICAL FIELD

The present invention relates to an input system, an input method, and a program.

### BACKGROUND ART

An input device has been developed capable of inputting characters depending on an operation of a finger on a touch screen. For example, Patent Literature 1 discloses an input device capable of inputting characters by a gesture of moving a finger twice from a position where the finger touches a touch pad. In addition, Patent Literature 2 discloses an input device in which an area of a touch screen is divided into three areas of side areas and a center area, and when the gesture is performed after the center area is touched, characters can be input, and when the gesture is performed after the area is touched again, a menu can be selected that is installed in a character input application such as conversion and deletion of character input.

### CITATION LIST

### Patent Literature

Patent Literature 1: Japanese Patent No. 5427940
Patent Literature 2: Japanese Patent No. 5969552

### SUMMARY OF THE INVENTION

### Technical Problem

However, regarding operation on the touch screen by a paralyzed upper limb, the operation itself is difficult, and there is a problem that characters cannot be appropriately input.

An object of the disclosed technology is to improve operability of character input.

### Solution to Problem

The disclosed technology is an input system including an input device and an information processing device, in which the input device includes: an operation unit that includes a plurality of protrusions and receives operation by a body of an operator; and a sensor that measures a three-dimensional pressure value obtained by pressing by the plurality of protrusions, and the information processing device includes: a measurement value receiving unit that receives data indicating a measurement value from the input device; and a measurement value processing unit that selects a character to be input on the basis of the measurement value.

### Advantageous Effects of the Invention

The operability of character input can be improved.

### BRIEF DESCRIPTION OF DRAWINGS

FIG. 1 is a diagram illustrating a system configuration example of an input system.

FIG. 2 is a perspective view illustrating an example of an input device.

FIG. 3 is a top view illustrating an example of the input device.

FIG. 4 is a cross-sectional view illustrating an example of the input device.

FIG. 5 is a perspective view illustrating a structure of a lower surface of the input device.

FIG. 6 is a perspective view illustrating an example of an elastic unit included in the input device.

FIG. 7 is a perspective view illustrating an example of a sensor included in the input device.

FIG. 8 is a diagram illustrating a functional configuration example of an information processing device.

FIG. 9 is a diagram illustrating an example of direction character correspondence information.

FIG. 10 is a diagram for explaining a direction selection method.

FIG. 11 is a flowchart illustrating an example of a flow of measurement value processing.

FIG. 12 is a diagram illustrating examples of variations of an operation unit.

FIG. 13 is a diagram illustrating a hardware configuration example of a computer.

### DESCRIPTION OF EMBODIMENTS

Hereinafter, an embodiment of the present invention (present embodiment) will be described with reference to the drawings. The embodiment described below is merely an example, and an embodiment to which the present invention is applied is not limited to the embodiment described below.

### Outline of Present Embodiment

An input system according to the present embodiment includes an input device and an information processing device. The input device including a concave operation unit transmits data indicating a measurement value by a three-dimensional pressure sensor installed at the bottom of the operation unit to the information processing device. The information processing device performs display control to move a cursor displayed on a screen on the basis of the measurement value indicated in the received data.

### (System Configuration Example of Input System)

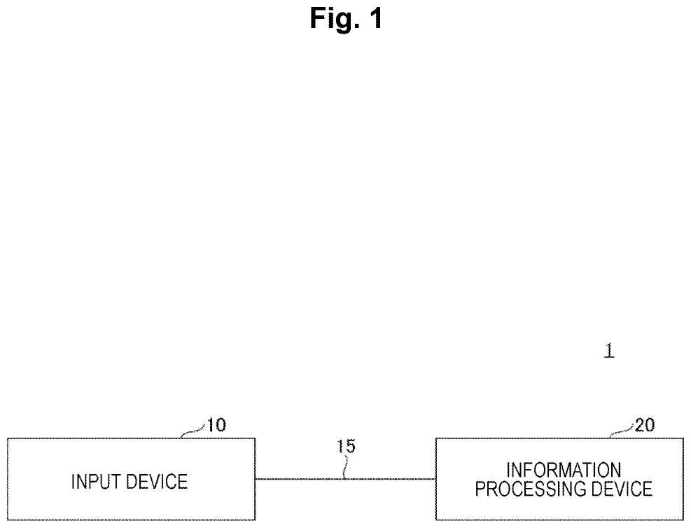

FIG. 1 is a diagram illustrating a system configuration example of an input system. An input system 1 includes an input device 10 and an information processing device 20.

The input device 10 is connected to the information processing device 20 to be able to communicate with each other via a communication line 15. Note that a communication method between the input device 10 and the information processing device 20 may be wired or wireless.

The input device 10 includes a concave operation unit, and transmits data indicating a measurement value by a three-dimensional pressure sensor installed at the bottom of the operation unit to the information processing device at regular intervals via the communication line 15 or the like.

The information processing device 20 is a tablet terminal, a personal computer (PC), a glasses-type display, or the like, and is a device to be operated. The information processing device 20 performs display control of a display or the like to move a cursor displayed on a screen or change a selection menu on the basis of the measurement value indicated in the received data.

### (Structure of Input Device)

Next, a structure of input device 10 will be described with reference to the drawings.

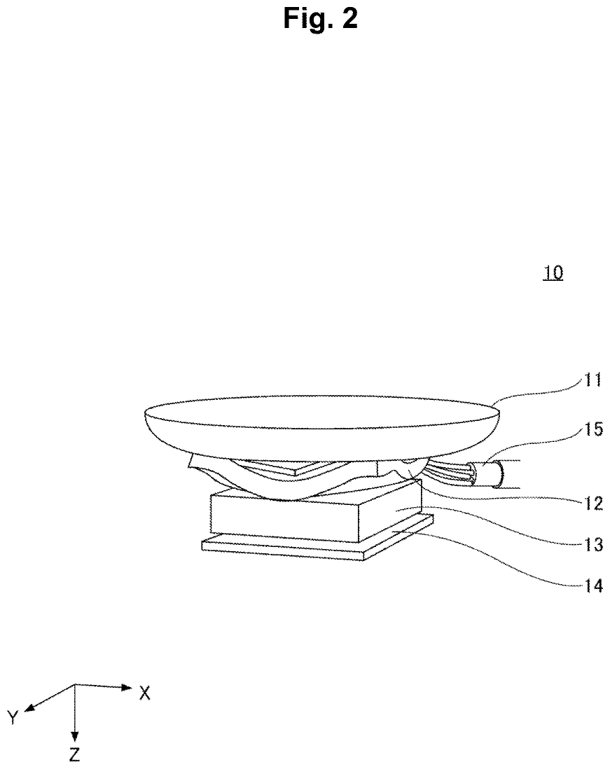

FIG. 2 is a perspective view illustrating an example of the input device. The input device 10 includes an operation unit 11, an elastic unit 12, a sensor housing 13, and an installation surface fixing unit 14.

The operation unit 11 is formed of a concave member, and is pressed mainly in a Z-axis positive direction by the body (hand, finger, or the like) of an operator. Note that, in a case where the input device 10 is installed on a table or the like, the Z-axis positive direction is a direction close to the vertically downward direction in an installed state.

The elastic unit 12 is an elastic member for preventing the operation unit 11 from being separated from the sensor when force is applied to the operation unit 11.

The sensor housing 13 is a housing in which the three-dimensional pressure sensor is housed.

The installation surface fixing unit 14 is a member for fixing an installation surface in the installed state in the case where the input device 10 is installed on the table or the like. The installation surface fixing unit 14 is formed of, for example, an anti-vibration gel or the like that absorbs shaking.

The communication line 15 is connected to the three-dimensional pressure sensor housed in the sensor housing 13.

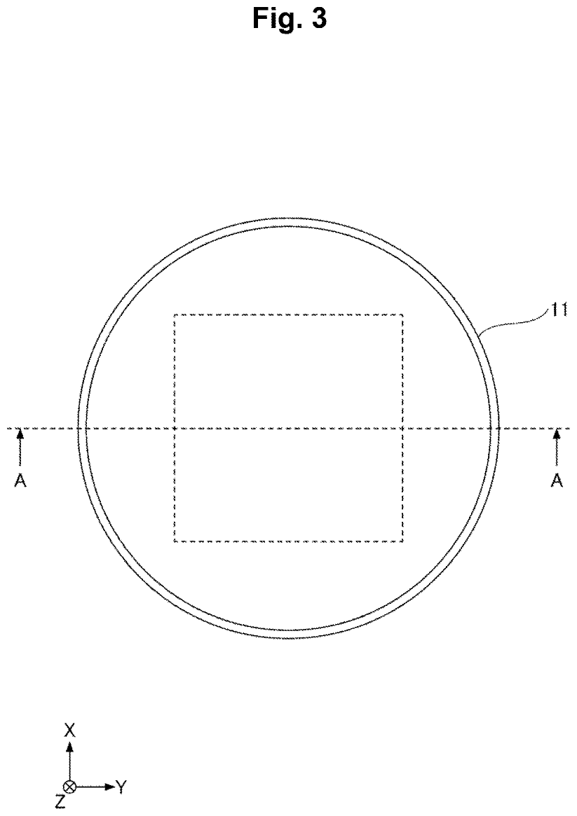

FIG. 3 is a top view illustrating an example of the input device. The operation unit 11 has a circular shape when viewed from an upper surface in a Z-axis negative direction. In a coordinate system in the following description, a sensor plane is an XY plane, and the center of the circle of the operation unit 11 on the XY plane is an origin.

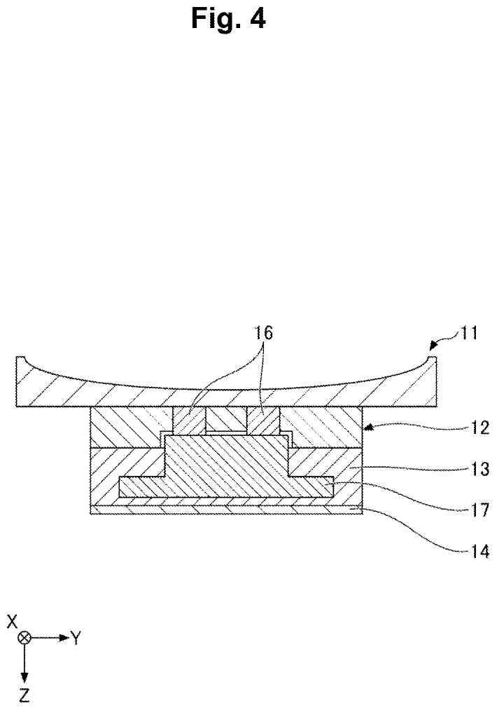

FIG. 4 is a cross-sectional view illustrating an example of the input device. FIG. 4 is an AA cross-sectional view of FIG. 3. The operation unit 11 includes protrusions 16 for pressing a sensor 17. The protrusions 16 come into contact with the sensor 17 and press the sensor 17 in the Z-axis positive direction. Note that, the protrusions 16 may be in direct contact with the sensor 17, or may be configured to press the sensor 17 through the elastic unit 12 and may not be in direct contact with the sensor 17.

The sensor 17 is the three-dimensional pressure sensor housed in the sensor housing 13, and measures pressure from the protrusions 16 at four locations.

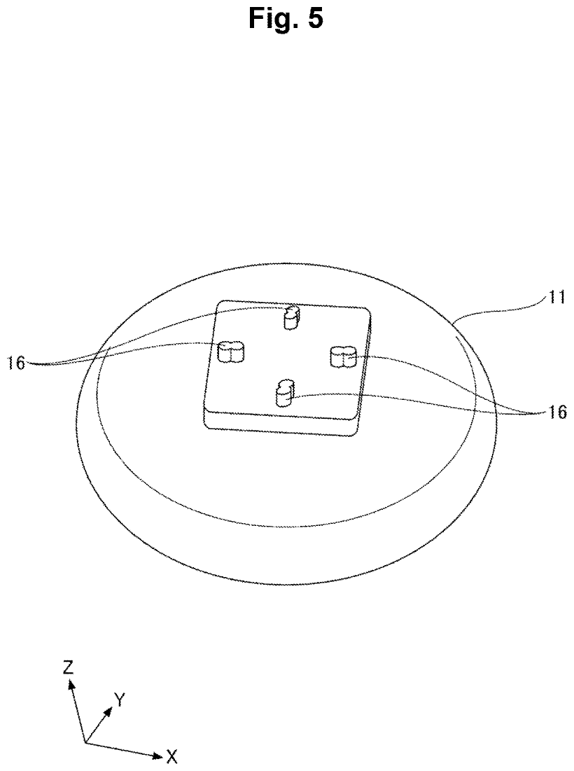

FIG. 5 is a perspective view illustrating a structure of a lower surface of the input device. The operation unit 11 includes the protrusions 16 at four locations slightly away from the center of the circle formed by the operation unit 11 in the vertical and horizontal directions. With the four protrusions 16, force is appropriately applied in eight directions (up, down, left, right, and oblique four directions) at an input of the sensor 17 that is a small three-dimensional pressure sensor. The sensor 17 measures pressure values (Px, Py, Pz) in the X, Y, and Z directions.

Note that the number of the protrusions 16 described above is an example, and other numbers may be used. That is, the operation unit 11 includes the plurality of protrusions 16 and receives operation by the body of the operator. Then, the sensor 17 measures a three-dimensional pressure value obtained by pressing by the plurality of protrusions.

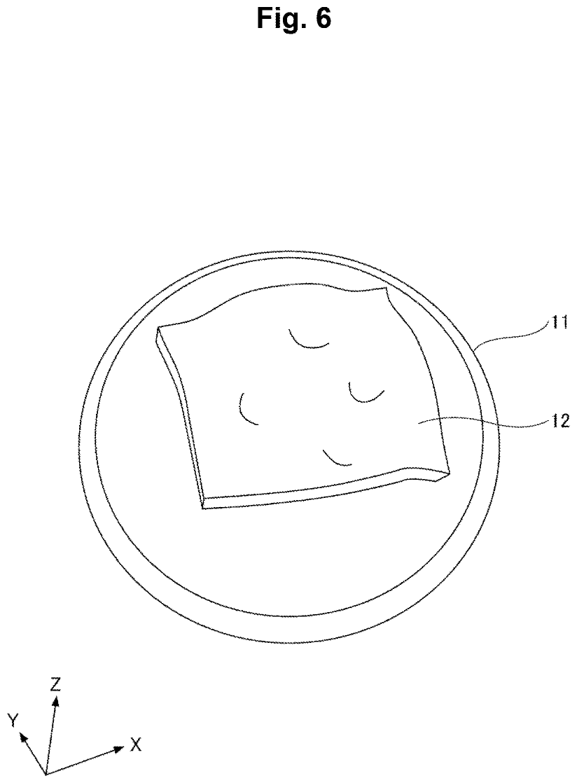

FIG. 6 is a perspective view illustrating an example of the elastic unit included in the input device. In the example illustrated in FIG. 6, the elastic unit 12 is formed to cover the protrusions 16. As a result, even when forces different from each other are respectively applied to the four protrusions 16, inclination of the operation unit 11 is absorbed by the elastic unit 12, so that a state in which the protrusions 16 can press the sensor 17 is maintained.

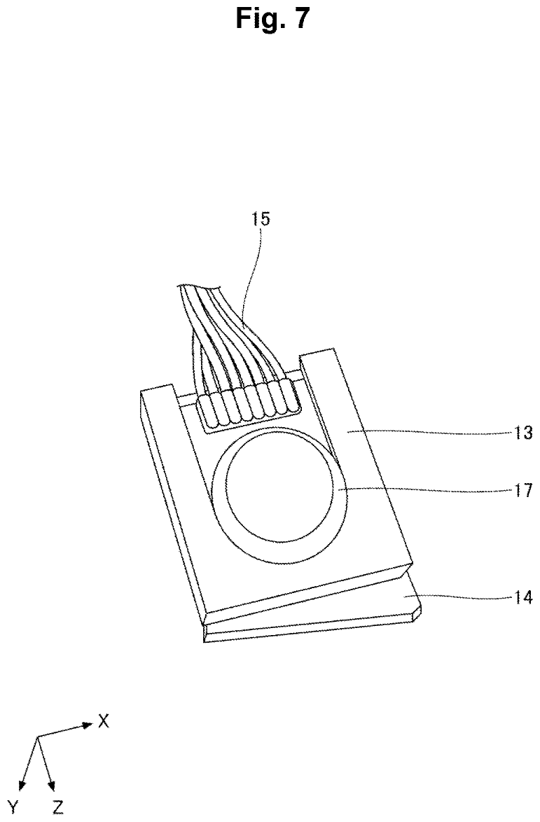

FIG. 7 is a perspective view illustrating an example of the sensor included in the input device. The sensor 17 is housed in the sensor housing 13 and connected to the communication line 15. An installation surface of the sensor housing 13 is fixed to an installation target such as a table in the installed state by the installation surface fixing unit 14.

### (Functional Configuration Example of Information Processing Device)

Next, functions of the information processing device 20 will be described.

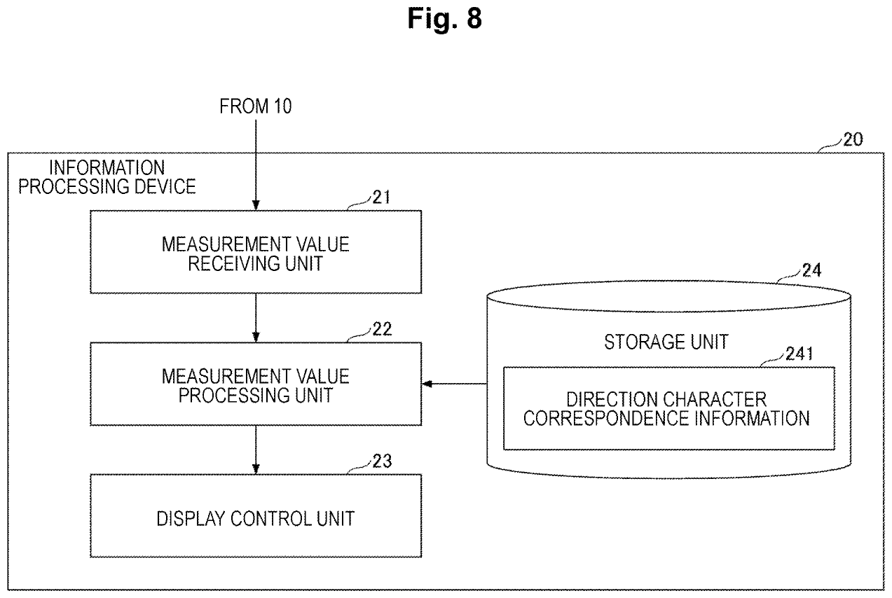

FIG. 8 is a diagram illustrating a functional configuration example of the information processing device. The information processing device 20 includes a measurement value receiving unit 21, a measurement value processing unit 22, a display control unit 23, and a storage unit 24.

The measurement value receiving unit 21 receives data (hereinafter, also referred to as measurement data) indicating measurement values (Px, Py, Pz) from the input device 10.

The measurement value processing unit 22 executes screen operation processing such as character input and selection menu change on the basis of the measurement values. When executing character input operation, the measurement value processing unit 22 refers to direction character correspondence information 241 stored in the storage unit 24 to determine a character corresponding to the measurement values.

The display control unit 23 performs display control of a display or the like to reflect a processing result by the measurement value processing unit 22.

The storage unit 24 stores the direction character correspondence information 241. The direction character correspondence information 241 is information indicating a correspondence between a direction and a character.

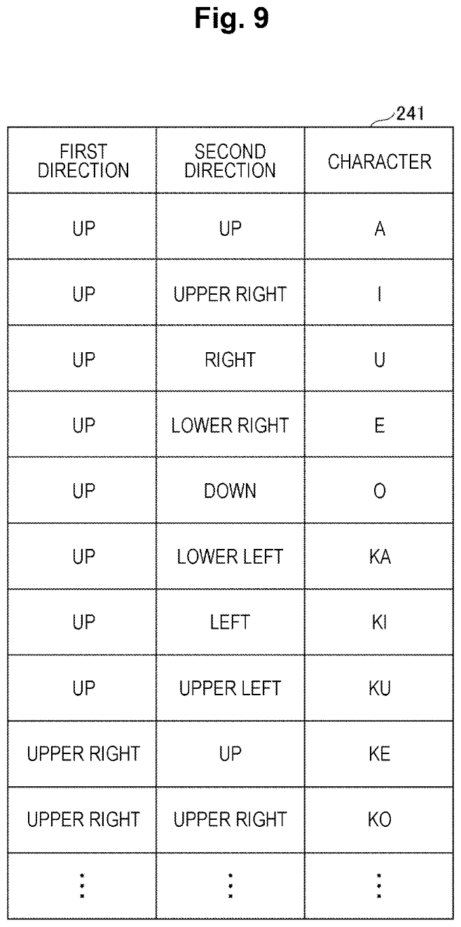

FIG. 9 is a diagram illustrating an example of the direction character correspondence information. In processing to be described later, the measurement value processing unit 22 selects a first direction and a second direction on the basis of the measurement values. The direction character correspondence information 241 is information for determining a character on the basis of the selected first direction and second direction.

Specifically, the direction character correspondence information 241 includes “first direction”, “second direction”, and “character” as items.

A value of the item “first direction” is a value indicating a direction selected as the first direction, and is, for example, a value indicating any of eight directions such as “up”, “upper right”, and the like.

A value of the item “second direction” is a value indicating a direction selected as the second direction, and is, for example, a value indicating any of eight directions such as “up”, “upper right”, and the like, similarly to the first direction.

A value of the item “character” is a value indicating a character determined on the basis of the directions.

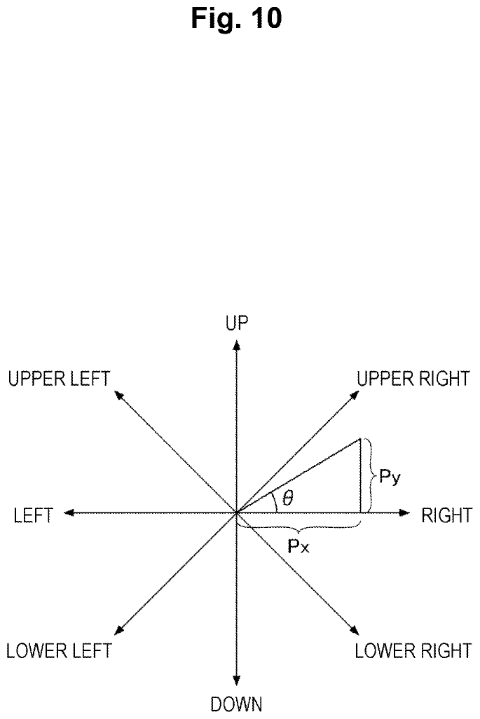

FIG. 10 is a diagram for explaining a direction selection method. The measurement value processing unit 22 selects the first direction and the second direction on the basis of the measurement values. Specifically, on the basis of the measurement values Px and Py, a direction close to a vector (Px, Py) is selected from eight directions on the basis of an angle θ formed by the vector (Px, Py) and an X-axis positive direction. As illustrated in FIG. 10, the eight directions are up, upper right, right, lower right, down, lower left, left, and upper left.

For example, in the case of θ=30 degrees, the measurement value processing unit 22 selects the upper right (θ=45 degrees) that is the closest direction. In the case of θ=20 degrees, the measurement value processing unit 22 selects the right (θ=0 degrees) that is the closest direction.

### (Operation Example of Information Processing Device)

Next, operation of the information processing device 20 will be described. The information processing device 20 starts measurement value processing by receiving data indicating a measurement value from the input device 10 periodically, for example, every 1 second.

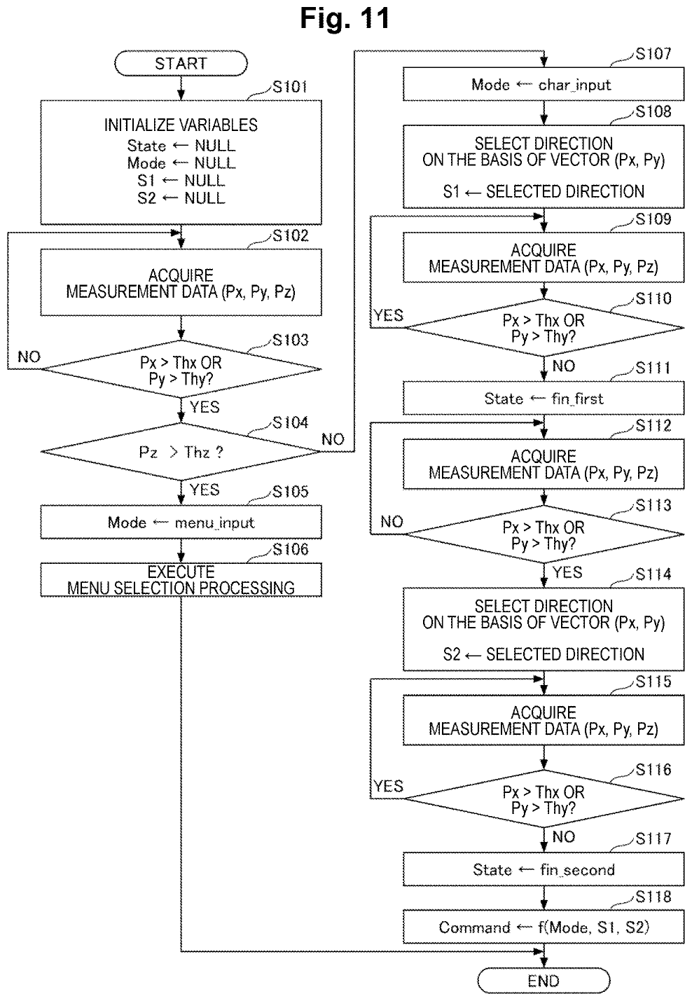

FIG. 11 is a flowchart illustrating an example of a flow of the measurement value processing. The measurement value processing unit 22 initializes variables (step S101). Specifically, NULL is substituted into variables State, Mode, S1, and S2. Note that NULL is a value indicating that there is nothing.

A value indicating a character input mode or a menu selection mode is substituted into the variable Mode. For example, “char input” in the case of the character input mode and “menu_input” in the case of the menu selection mode are substituted into the variable Mode.

A value indicating a progress status in the character input mode is substituted into the variable State. For example, “fin_first” when the first direction is determined and “fin_second” when the second direction is determined are substituted into the variable State.

A value indicating the first direction is substituted into the variable S1. A value indicating the second direction is substituted into the variable S2.

Next, the measurement value processing unit 22 acquires the measurement data (Px, Py, Pz) (step S102).

Subsequently, the measurement value processing unit 22 determines whether or not the measurement value Px is greater than a threshold value Thx or the measurement value Py is greater than a threshold value Thy (step S103). When determining that the measurement value Px is not greater than the threshold value Thx and the measurement value Py is not greater than the threshold value Thy (step S103: NO), the measurement value processing unit 22 returns to the processing of step S102.

When determining that the measurement value Px is greater than the threshold value Thx or the measurement value Py is greater than the threshold value Thy (step S103: YES), the measurement value processing unit 22 determines whether or not the measurement value Pz is greater than a threshold value Thz (step S104).

When determining that the measurement value Pz is greater than the threshold value Thz (step S104: YES), the measurement value processing unit 22 substitutes “menu_input” into the variable Mode (step S105) and executes menu selection processing (step S106).

When determining that the measurement value Pz is not greater than the threshold value Thz (step S104: NO), the measurement value processing unit 22 substitutes “char input” into the variable Mode (step S107). Subsequently, the measurement value processing unit 22 selects a direction by the method illustrated in FIG. 10 on the basis of the vector (Px, Py), and substitutes a value indicating the selected direction (first direction) into the variable S1 (step S108).

Next, the measurement value processing unit 22 acquires the measurement data (Px, Py, Pz) (step S109). Subsequently, the measurement value processing unit 22 determines whether or not the measurement value Px is greater than the threshold value Thx or the measurement value Py is greater than the threshold value Thy (step S110).

When determining that the measurement value Px is greater than the threshold value Thx or the measurement value Py is greater than the threshold value Thy (step S110: YES), the measurement value processing unit 22 returns to step S109.

When determining that the measurement value Px is not greater than the threshold value Thx and the measurement value Py is not greater than the threshold value Thy (step S110: NO), the measurement value processing unit 22 substitutes “fin first” into the variable State (step S111).

Next, the measurement value processing unit 22 acquires the measurement data (Px, Py, Pz) (step S112).

Subsequently, the measurement value processing unit 22 determines whether or not the measurement value Px is greater than the threshold value Thx or the measurement value Py is greater than the threshold value Thy (step S113). When determining that the measurement value Px is not greater than the threshold value Thx and the measurement value Py is not greater than the threshold value Thy (step S113: NO), the measurement value processing unit 22 returns to the processing of step S112.

When determining that the measurement value Px is greater than the threshold value Thx or the measurement value Py is greater than the threshold value Thy (step S113: YES), the measurement value processing unit 22 selects a direction by the method illustrated in FIG. 10 on the basis of the vector (Px, Py), and substitutes a value indicating the selected direction (second direction) into the variable S2 (step S114).

Next, the measurement value processing unit 22 acquires the measurement data (Px, Py, Pz) (step S115).

Subsequently, the measurement value processing unit 22 determines whether or not the measurement value Px is greater than the threshold value Thx or the measurement value Py is greater than the threshold value Thy (step S116).

When determining that the measurement value Px is greater than the threshold value Thx or the measurement value Py is greater than the threshold value Thy (step S116: YES), the measurement value processing unit 22 returns to step S115. When determining that the measurement value Px is not greater than the threshold value Thx and the measurement value Py is not greater than the threshold value Thy (step S116: NO), the measurement value processing unit 22 substitutes “fin_second” into the variable State (step S117).

Next, the measurement value processing unit 22 executes a command on the basis of f(Mode, S1, S2) (step S117). The f(Mode, S1, S2) means that a character depending on the values of the variables S1 and S2 is selected in a case where the value of the variable Mode is “char_input”.

Specifically, the measurement value processing unit 22 refers to the direction character correspondence information illustrated in FIG. 9, and select a character on the basis of the value indicating the first direction stored in the variable S1 and the value indicating the second direction stored in the variable S2.

As described above, the measurement value processing unit 22 selects the character input mode or the menu selection mode depending on the measurement value Pz, and selects a character depending on the measurement values Px and Py in a case where the character input mode is selected.

### (Variations of Operation Unit)

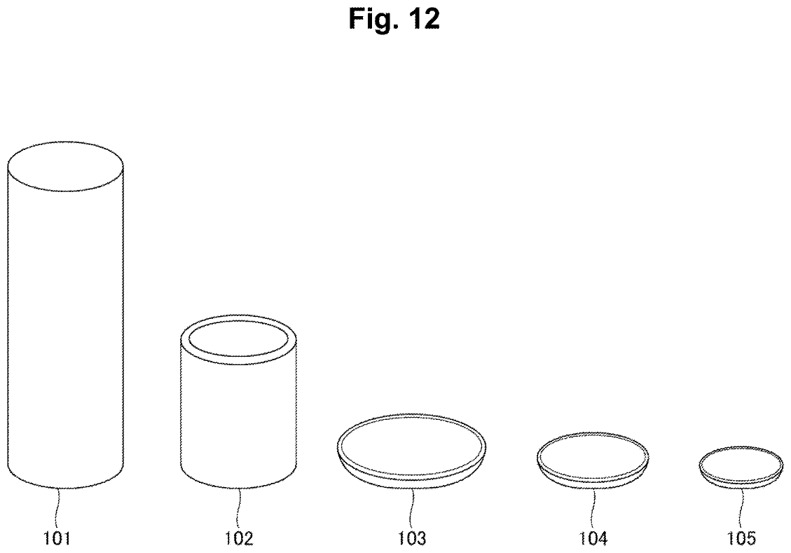

FIG. 12 is a diagram illustrating examples of variations of the operation unit. The operation unit 11 may have various shapes as illustrated in FIG. 12. For example, an operation tool 101 and an operation tool 102 are cylindrical (stick type) operation tools. The operation tool 101 is a long type operation tool, and the operation tool 102 is a short type operation tool.

An operation tool 103, an operation tool 104, and an operation tool 105 are bowl-shaped (dish type) operation tools. Regarding their sizes, the operation tool 103 is large, the operation tool 104 is medium, and the operation tool 105 is small.

As described above, operation tools of various shapes and sizes can be applied as the operation unit 11. Note that, it is sufficient that the shape and size of each unit of the input device 10 are designed in accordance with the shape of operation unit 11.

### (Hardware Configuration Example According to Present Embodiment)

The information processing device 20 can be implemented, for example, by causing a computer to execute a program describing processing content described in the present embodiment. Note that the “computer” may be a physical machine or a virtual machine on a cloud. In a case where a virtual machine is used, “hardware” to be described herein is virtual hardware.

The program can be stored and distributed by being recorded in a computer-readable recording medium (portable memory or the like). Furthermore, the program can also be provided through a network such as the Internet or an electronic mail.

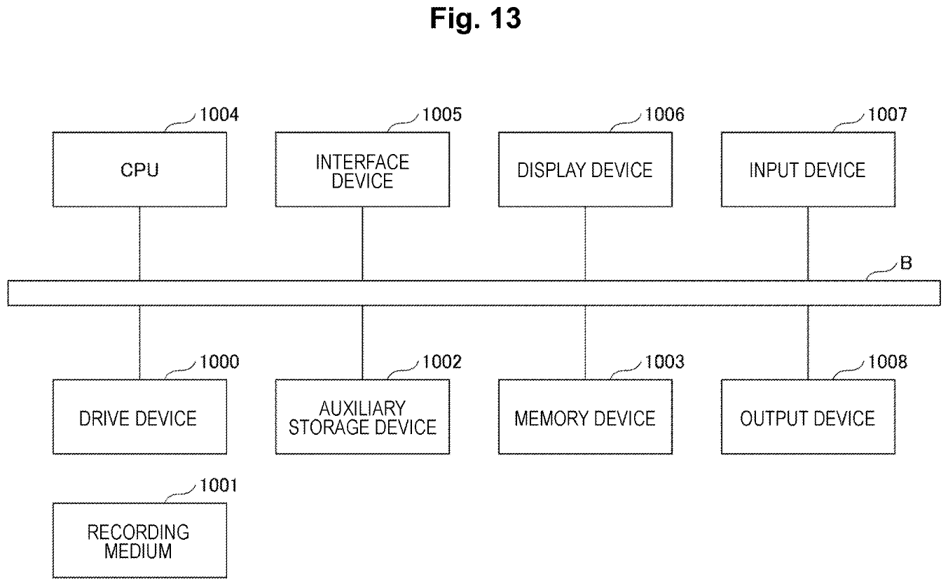

FIG. 13 is a diagram illustrating a hardware configuration example of the computer. The computer in FIG. 13 includes a drive device 1000, an auxiliary storage device 1002, a memory device 1003, a CPU 1004, an interface device 1005, a display device 1006, an input device 1007, an output device 1008, and the like, which are connected to each other by a bus B.

The program for implementing processing in the computer is provided through a recording medium 1001 such as a CD-ROM or a memory card, for example. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is made, the memory device 1003 reads the program from the auxiliary storage device 1002, and stores the program therein. The CPU 1004 implements a function related to the device in accordance with the program stored in the memory device 1003. The interface device 1005 is used as an interface for connecting to a network. The display device 1006 displays a graphical user interface (GUI) or the like according to the program. The input device 1007 includes a keyboard and a mouse, buttons, a touch panel, or the like, and is used to input various operation instructions. The output device 1008 outputs a computation result. Note that the computer may include a graphics processing unit (GPU) or a tensor processing unit (TPU) instead of the CPU 1004, and may include a GPU or a TPU in addition to the CPU 1004. In this case, for example, the processing may be shared and executed such that the GPU or the TPU executes processing requiring special computation and the CPU 1004 executes other processing.

### Effects of Present Embodiment

According to the input system 1 according to the present embodiment, the input device 10 including the concave operation unit transmits data indicating the measurement value by the three-dimensional pressure sensor installed at the bottom of the operation unit to the information processing device 20. On the basis of the measurement values indicated in the received data, the information processing device 20 selects the character input mode or the menu selection mode depending on the measurement value Pz, and selects a character depending on the measurement values Px and Py in a case where the character input mode is selected. As a result, characters can be input by a small motion by, for example, a paralyzed upper limb or the like, and the operability of character input can be improved.

### Summary of Embodiment

In the present specification, at least the input device, the input system, and the input method described in the following sections are described.

### (Clause 1)

An input system including an input device and an information processing device, in which
the input device includes:
an operation unit that includes a plurality of protrusions and receives operation by a body of an operator; and
a sensor that measures a three-dimensional pressure value obtained by pressing by the plurality of protrusions, and
the information processing device includes:
a measurement value receiving unit that receives data indicating a measurement value from the input device; and
a measurement value processing unit that selects a character to be input on the basis of the measurement value.

### (Clause 2)

The input system according to clause 1, in which the measurement value includes pressure values in an X direction, a Y direction, and a Z direction, and
the measurement value processing unit selects a character input mode or a menu selection mode depending on the pressure value in the Z direction, and selects a character depending on the pressure value in the X direction and the pressure value in the Y direction in a case where the character input mode is selected.

### (Clause 3)

The input system according to clause 1 or 2, in which
the measurement value processing unit selects a first direction and a second direction depending on the pressure value in the X direction and the pressure value in the Y direction, and selects a character on the basis of the first direction and second direction selected.

### (Clause 4)

The input system according to clause 3, in which
the measurement value processing unit selects the first direction and the second direction on the basis of an angle formed by a vector including the pressure value in the X direction and the pressure value in the Y direction and an X-axis positive direction.

### (Clause 5)

An input method executed by an input system including an input device and an information processing device,
the input device including:
an operation unit that includes a plurality of protrusions and receives operation by a body of an operator; and
a sensor that measures a three-dimensional pressure value obtained by pressing by the plurality of protrusions,
the input method including:
receiving, by the information processing device, data indicating a measurement value from the input device; and
selecting, by the information processing device, a character to be input on the basis of the measurement value.

### (Clause 6)

A program for causing a computer to function as each unit in the information processing device included in the input system according to any one of clauses 1 to 4.

Although the present embodiment has been described above, the present invention is not limited to such a specific embodiment, and various modifications and changes can be made within the scope of the gist of the present invention described in the claims.

### REFERENCE SIGNS LIST

1 Input system
10 Input device
11 Operation unit
12 Elastic unit
13 Sensor housing
14 Installation surface fixing unit
15 Communication line
16 Protrusion
17 Sensor
20 Information processing device
21 Measurement value receiving unit
22 Measurement value processing unit
23 Display control unit
24 Storage unit
241 Direction character correspondence information
1000 Drive device
1001 Recording medium
1002 Auxiliary storage device
1003 Memory device
1004 CPU
1005 Interface device
1006 Display device
1007 Input device
1008 Output device

1. An input system comprising:
an input device including:
an operation unit that includes a plurality of protrusions and configured to receive an input operation by an operator; and
a sensor configured to be pressed by pressing by the plurality of protrusions to measure pressure component values in three directions that are mutually perpendicular, and
an information processing device including circuitry configured to:
receive data indicating the pressure component values, a from the input device, and
identify a character that is entered in the input operation, based on the pressure component values.

2. The input system according to claim 1, wherein
the pressure component values respectively include first, second, and third pressure component values in an X direction, a Y direction, and a Z direction, and
the circuitry is configured to
determine which of operation modes relates to the input operation, based on the third pressure component value, and
identify the character entered in a first operation mode, based on the first pressure component value and the second pressure component value, upon determining that the first operation mode of the operation modes relates to the input operation.

3. The input system according to claim 2, wherein
the circuitry is configured to
determine a first direction and a second direction of the three directions, based on the first pressure component value and the second pressure component value, and
identify the character based on the determined first direction and second direction.

4. The input system according to claim 3, wherein
the circuitry is configured to
determine the first direction and the second direction based on an angle of a vector with respect to an X-axis direction, the vector being defined by the first pressure component value and the second pressure component value.

5. An input method executed by an input system including a plurality of protrusions and an information processing device, the input method comprising:
receiving an input operation;
pressing a sensor to measure pressure component values in three directions that are mutually perpendicular, using the plurality of protrusions; and
identifying a character that is entered in the input operation, based on the pressure component values.

6. A non-transitory computer readable medium storing a program for causing a computer to execute the input method of claim 5.
